(19) United States
(12) Patent Application Publication
(10) Pub. No.: US 2011/0077752 A1
(43) Pub. Date: Mar. 31, 2011

(54) SAMPLE TESTING APPARATUS AND METHOD OF CONTROLLING SAMPLE TESTING APPARATUS

(75) Inventors: Yuichi Hamada, Kobe-shi (JP); Masaharu Shibata, Kobe-shi (JP); Daigo Fukuma, Kobe-shi (JP)

(73) Assignee: SYSMEX CORPORATION, Kobe-shi (JP)

(21) Appl. No.: 12/893,990

(22) Filed: Sep. 29, 2010

(30) Foreign Application Priority Data
Sep. 30, 2009 (JP) 2009-229030

(51) Int. Cl. G05B 21/00

(52) U.S. Cl. 700/73

(57) ABSTRACT

A sample testing apparatus which can be operated by a plurality of use authorities, comprising: a measurement mechanism for measuring a sample; a setting data storage section for storing setting data used to operate the apparatus, the setting data at least comprising mechanism control data relating to operation control of the measurement mechanism and information output data relating to information output; and a controller for controlling an operation of the sample testing apparatus is disclosed.

A method for controlling a sample testing apparatus is also disclosed.

### RELATED APPLICATIONS

This application claims priority under 35 U.S.C. §119 to Japanese Patent Application No. 2009-229030 filed on Sep. 30, 2009, the entire content of which is hereby incorporated by reference.

### FILED OF THE INVENTION

The present invention relates to a sample testing apparatus for testing a sample such as blood or urine, and a method for controlling such a sample testing apparatus.

### BACKGROUND

Conventionally, there is known an analyzing apparatus in which analyzing conditions can be changed according to a plurality of different authorization levels for use. For example, Japanese laid-open patent publication 2004-309249 discloses an analyzing apparatus in which different authorization levels for use are stored in association with different user IDs to authorize temporary change or permanent change of analysis conditions according to different authorization levels.

The analyzing apparatus disclosed in Japanese laid-open patent publication 2004-309249 provides three different authorization levels for use, R1, R2, and R3, wherein the analyzing apparatus authorizes the authorization level for use R1 to temporarily and permanently change the analysis conditions, and authorizes the authorization level for use R2 to just temporarily change the analysis conditions, while rendering the authorization level for use R3 unauthorized for any kind of change to the analysis conditions. The authorization level for use R1 is an authority which a user (operator in charge of analysis) is entitled to, and the authorization level for use R2 is an authority which a serviceman in charge of maintenance (operator in charge of maintenance) is entitled to. In the analyzing apparatus disclosed in Japanese laid-open patent publication 2004-309249, the user alone is authorized to make permanent change of the analysis conditions, whereas the serviceman can change the analysis conditions not permanently but only temporarily.

The analyzing apparatus disclosed in Japanese laid-open patent publication 2004-309249, wherein the serviceman can only change the analysis conditions temporarily, includes a disadvantage: the user has no choice but to use original setting data when the user analyzes a sample, regardless of the setting data already adjusted to optimal values by the serviceman during his maintenance work. The disadvantage imposes such a time-consuming load on the user that the user has to readjust the setting data to the optimal values used in the maintenance work when analyzing the sample.

Some of the pieces of setting data in the analyzing apparatus, such as setting data of information output, have no optimal values and should be suitably changed by the user depending on, for example, use and situation. When such a particular setting data is changed during the maintenance work, any change made to the setting data should not affect the user's operation of the analyzing apparatus.

### SUMMARY OF THE INVENTION

The scope of the invention is defined solely by the appended claims, and is not affected to any degree by the statements within this summary.

A first aspect of present invention is a sample testing apparatus which can be operated by a plurality of use authorities, comprising: a measurement mechanism for measuring a sample; a setting data storage section for storing setting data used to operate the apparatus, the setting data at least comprising mechanism control data relating to operation control of the measurement mechanism and information output data relating to information output; and a controller for controlling an operation of the sample testing apparatus, wherein the controller: receives input of identification information for identifying an operator; authorizes change of the mechanism control data and change of the information output data when the received identification information corresponds to a first use authority to which an operator in charge of maintenance is entitled; authorizes the change of the information output data while forbidding the change of the mechanism control data when the received identification information corresponds to a second use authority to which an operator in charge of testing a sample is entitled; and operates, when the received identification information corresponds to the second use authority, the sample testing apparatus based on the mechanism control data stored in the setting data storage section and the information output data inputted by the operator identified by the received identification information.

A second aspect of the present invention is a sample testing apparatus which can be operated by a plurality of use authorities, the apparatus comprising: a measurement mechanism for measuring a sample; an identification information receiving unit for receiving input of identification information for identifying an operator; a first storage section for storing mechanism control data relating to operation control of the measurement mechanism; a second storage section for storing information output data relating to information output; and a controller, wherein the controller: stores the mechanism control data changed by the operator in the first storage section when the identification information received by the identification information receiving unit corresponds to a first use authority to which an operator in charge of maintenance is entitled; and stores the information output data changed by the operator in the second storage section when the identification information received by the identification information receiving unit corresponds to a second use authority to which an operator in charge of testing a sample is entitled, and operates the apparatus based on the data stored in the first and second storage sections.

A third aspect of the present invention is a sample testing apparatus which can be operated by a plurality of use authorities, comprising: a measurement mechanism for measuring a sample; an identification information receiving means for receiving input of identification information for identifying an operator; a setting data storage section for storing setting data used to operate the apparatus, the setting data at least comprising setting data relating to operation control of the measurement mechanism and setting data relating to information output; a first change accepting means for accepting change of the setting data relating to operation control of the measurement mechanism; a second change accepting means for accepting change of the setting data relating to information output; and a controller, wherein the controller: authorizes the changes of the setting data accepted by the first and second change accepting means when the identification information received by the identification information receiving means corresponds to a first use authority to which an operator in charge of maintenance is entitled; forbids the change of the setting data accepted by the first change accepting means and authorizes the change of the setting data accepted by the second change accepting means when the identification information received by the identification information receiving means corresponds to a second use authority to which an operator in charge of testing a sample is entitled; and operates, when the identification information received by the identification information receiving means corresponds to a second use authority, the apparatus based on the setting data changed by the first change accepting means and the setting data changed by the operator identified based on the received identification information using the second change accepting means.

A fourth aspect of the present invention is a method for controlling a sample testing apparatus provided with a measurement mechanism for measuring a sample, and a setting data storage section for storing setting data used to operate the apparatus, wherein the setting data at least comprises mechanism control data relating to operation control of the measurement mechanism and information output data relating to information output, the method comprising: receiving input of identification information for identifying an operator; authorizing change of the mechanism control data and change of information output data when the received identification information corresponds to a first use authority to which an operator in charge of maintenance is entitled; authorizing the change of the information output data while forbidding the change of the mechanism control data stored in the setting data storage section when the received identification information corresponds to a second use authority to which an operator in charge of testing a sample is entitled; and operating the sample testing apparatus based on the mechanism control data and the information output data inputted by the operator corresponding to the received identification information when the received identification information is the identification information corresponding to the second use authority.

### BRIEF DESCRIPTION OF THE DRAWINGS

FIG. 1 is a perspective view illustrating an overall structure of a sample testing apparatus according to an embodiment of the present invention;

FIG. 2 is a block diagram illustrating a structure of the sample testing apparatus according to the embodiment of the present invention wherein an information processing device includes a controller such as a CPU;

FIG. 3 is an example of setting data table illustrating a relationship between setting data of the sample testing apparatus according to the embodiment of the present invention and authorization levels for use;

FIG. 4 is a flowchart illustrating processing steps by the controller of the information processing device in the sample testing apparatus according to the embodiment of the present invention;

FIG. 5 illustrates an example of a login screen displayed on a display unit when the information processing device of the sample testing apparatus according to the embodiment of the present invention is turned on;

FIG. 6 is a flowchart illustrating processing steps in step S404 of FIG. 4 by the controller of the information processing device in the sample testing apparatus according to the embodiment of the present invention;

FIG. 7 illustrates an example of a menu screen displayed on the display unit based on a serviceman authority;

FIG. 8 illustrates an example of a service menu screen displayed on the display unit when selection of a service icon is received;

FIG. 9 illustrates an example of a screen for inputting sensitivity adjustment data;

FIG. 10 illustrates an example of an IPU setting screen;

FIG. 11 illustrates an example of a measurement unit setting screen;

FIG. 12 is a flowchart illustrating processing steps in step S405 of FIG. 4 by the controller of the information processing device in the sample testing apparatus according to the embodiment of the present invention;

FIG. 13 illustrates an example of a menu screen displayed on the display unit based on an administrator authority;

FIG. 14 illustrates an example of a screen for inputting calibration data;

FIG. 15 illustrates an example of a screen for inputting flag setting data;

FIG. 16 is a flowchart illustrating processing steps in step S406 of FIG. 4 by the controller of the information processing device in the sample testing apparatus according to the embodiment of the present invention; and

FIG. 17 is a block diagram illustrating a structure of an information processing device according to another embodiment of the present invention.

### DETAILED DESCRIPTION OF THE PREFERRED EMBODIMENTS

Hereinafter, a sample testing apparatus according to an embodiment of the present invention will be specifically described with reference to the accompanying drawings. An example of the sample testing apparatus in the description given below is a blood testing apparatus used to test a measurement specimen prepared by mixing blood with a reagent.

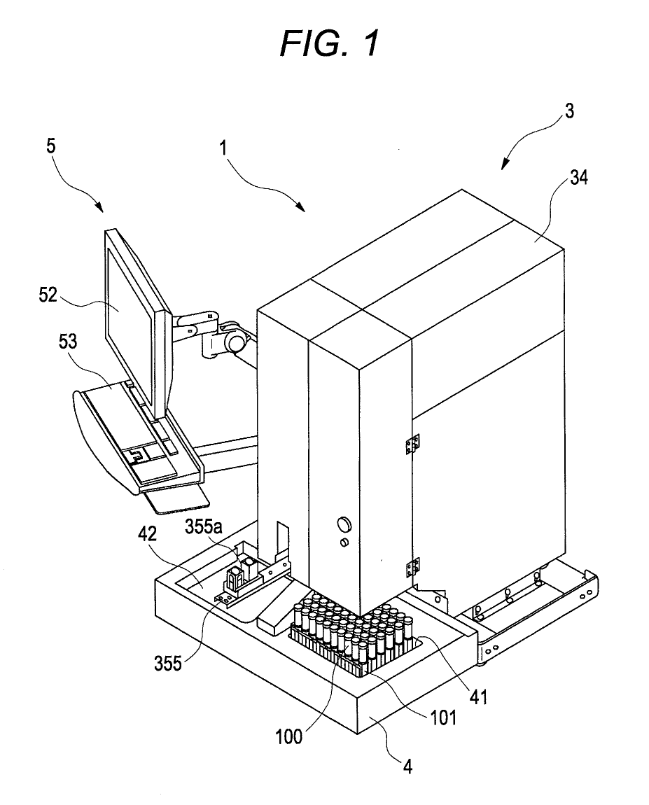

FIG. 1 is a perspective view illustrating an overall structure of the sample testing apparatus according to the embodiment of the present invention. As illustrated in FIG. 1, a sample testing apparatus 1 according to this embodiment includes a measurement unit 3, and an information processing device 5 provided on the lateral surface side of the measurement unit 3 and electrically connected to the measurement unit 3. The measurement unit 3 introduces into a cabinet 34 sample containers 100, 100, . . . containing therein blood as a sample, and mixes the blood sample contained in the introduced sample containers 100, 100, . . . with a reagent to prepare a measurement specimen. The measurement unit 3 measures a physical volume of the measurement specimen to obtain measurement data. The measurement unit 3 transmits the obtained measurement data to the information processing device 5. The information processing device 5 analyzes the measurement data received from the measurement unit 3 to generate an analysis result of blood components included in the blood sample.

A sampler 4 is provided on the front side of the measurement unit 3 to transport the sample containers 100, 100, . . . Specifically, the sample containers 100, 100, . . . containing therein the blood sample are housed in a sample rack 101. The sample rack 101 thus holding the sample containers 100, 100, . . . is retained by a pre-measurement rack storing unit 41, and thereby transversely transferred to a rack storing unit 42 when a measuring operation is finished.

The measurement unit 3 has a hand portion not illustrated in the drawing. Using the hand portion, the measurement unit 3 grabs the sample container 100 containing therein the blood sample to be measured from the sample rack 101 transversely transferred, and introduces the sample container 100 into the apparatus. More specifically, the measurement unit 3 is provided with a sample container feeding section 355 on the near side of the post-measurement rack storing unit 42. The measurement unit 3 sets the sample container 100 containing therein the blood sample to be measured in a sample container setting section 355a formed on the sample container feeding section 355 using the hand portion. The measurement unit 3 introduces the set sample container 100 into the apparatus, and mixes the blood sample contained in the introduced sample container 100 with a reagent to prepare a measurement specimen. The measurement unit 3 includes a flow cell into which the measurement specimen is poured, a light source for irradiating a liquid flow of the measurement specimen in the flow cell with light, and a light receiving section for receiving light generated by the light irradiated on the liquid flow by the light source (scattered light or fluorescent light). The measurement unit 3 obtains signals resulting from the blood components included in the measurement specimen using a conventional flow cytometry method.

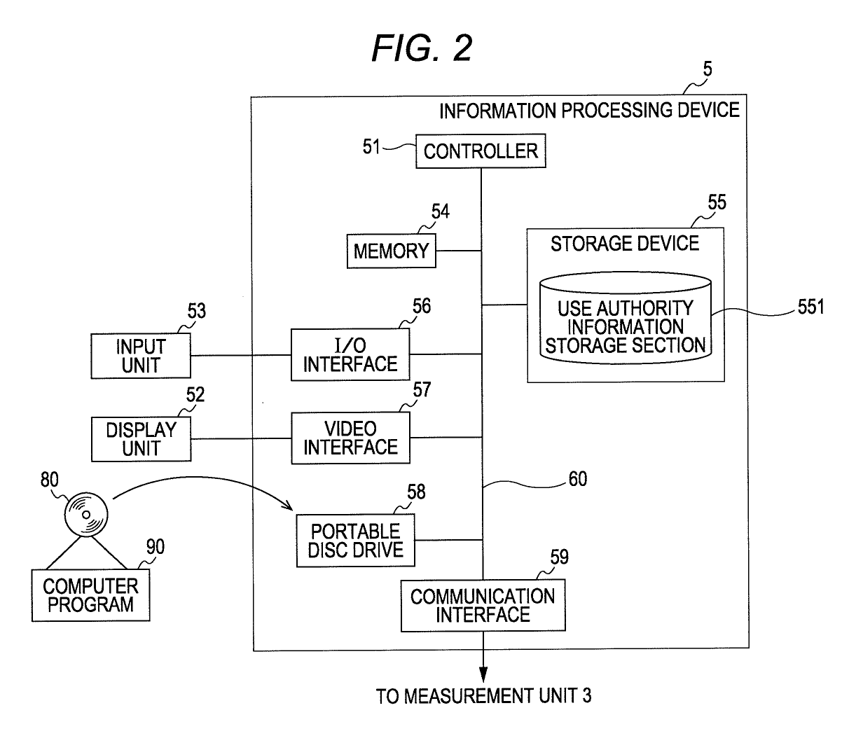

FIG. 2 is a block diagram illustrating a structure of the sample testing apparatus 1 according to the embodiment of the present invention wherein the information processing device 5 includes a controller such as a CPU. As illustrated in FIG. 2, the information processing device 5 has a controller (operation controller) 51 at least including, for example, a CPU (central processing unit), a memory 54, a storage device 55, an I/O interface 56, a video interface 57, a portable disc drive 58, a communication interface 59, and an internal bus 60 which connects these hardware components. The controller 51 is connected to the above-described hardware components of the information processing device 5 via the internal bus 60 to control the operations of the hardware components. The controller 51 further controls the operation of the measurement unit 3 based on a computer program 90 stored in the storage device 55.

The memory 54 includes a volatile memory such as an SRAM or flash memory. In the memory 54, a load module is developed when the computer program 90 is executed, and data temporarily generated when the computer program 90 is executed is stored.

The storage device 55 includes a built-in stationary storage device (hard disc). The computer program 90 stored in the storage device 55 is downloaded into the storage device 55 from a portable recording medium 80 such as a DVD or CD-ROM where information such as programs and data is stored by the portable disc drive 58. To execute the computer program 90, the program 90 is read from the storage device 55 into the memory 54. The computer program 90 may be a computer program downloaded from an external computer through the communication interface 59.

The communication interface 59 is connected to the internal bus 60, and further connected to an external network such as the Internet, LAN, or WAN to transmit and receive data to and from an external computer, the measurement unit 3, and the like. For example, the storage device 55 is not necessarily provided inside the information processing device 5. The storage device 55 may be an external recording medium such as an external storage connected to the information processing device 5 through the communication interface 59.

In this embodiment, the information processing device 5 is connected to a host computer HC through the communication interface 59. The host computer HC is a centralized information management device provided for management of information of samples to be tested by the sample testing apparatus 1, such as information of patients. The host computer HC transmits a measurement order to the sample testing apparatus 1 and obtains a sample analysis result from the information processing device 5.

The I/O interface 56 is connected to an input unit 53 including, for example, a keyboard and a tablet. The video interface 57 is connected to a display unit 52 such as a CRT monitor or an LCD.

The storage device 55 stores therein a plurality of pieces of setting data for controlling the operation of the sample testing apparatus 1 carried out by the measurement unit 3 and the information processing device 5. The storage device 55 stores therein setting data of a measurement mechanism provided in the measurement unit 3, setting data of information outputted from the information processing device 5, and setting data relating to conditions for analyzing the measurement data obtained by the information processing device 5.

The setting data of the measurement mechanism represents data for controlling the operation of the measurement mechanism such as optical axis adjustment data, hand position adjustment data, and light receiving element sensitivity adjustment data. The optical axis adjustment data is setting data for adjusting the optical axis of the irradiated light by the light source provided in the measurement unit 3. The hand position adjustment data is setting data for vertically adjusting the position of the sample container 100 held by the hand portion when the sample container 100 is fetched from the sample rack 101 transversely transferred by the sampler 4. The light receiving element sensitivity adjustment data is setting data for adjusting the gain of a signal outputted when the light receiving section provided in the measurement unit 3 receives light.

The setting data of the information output is setting data relating to the information output such as output conditions and output format when the information is outputted outside from the information processing device 5. More specifically, the information output setting data includes connection or no connection between the information processing device 5 and the host computer HC, and communication conditions.

The setting data relating to the measurement data analyzing conditions is setting data relating to conditions for analyzing the measurement data obtained by the information processing device 5 including flag setting data and calibration data. The flag setting data is setting data used to set conditions for determining whether or not, for example, a flag indicating that an obtained analysis result includes abnormal values should be affixed to the analysis result. The calibration data is setting data of a correction factor used when the information processing device 5 corrects the measurement data to generate an analysis result.

The storage device 55 is provided with a use authority information storage section 551 for storing therein information of a use authority to which an operator of the sample testing apparatus 1 is entitled so that the information is associated with identification information for identifying the operator. In the sample testing apparatus 1 according to this embodiment, different authorization levels for use are provided for an operator in charge of maintenance of the sample testing apparatus 1 (for example, serviceman), and an operator who tests a sample using the sample testing apparatus 1 (for example, laboratory technician), and an administrator of the sample testing apparatus 1. The use authority information storage section 551 stores therein any of the authorization level for use of the operator in charge of maintenance (hereinafter, referred to as “serviceman authority”), the authorization level for use of the operator who tests a sample using the sample testing apparatus 1 (hereinafter, referred to as “user authority”), and the authorization level for use of the administrator (hereinafter, referred to as “administrator authority”) in association with the identification information used to identify the operator.

In the sample testing apparatus 1 according to this embodiment, the setting data is inputted and changed, and the operation of the apparatus is controlled differently in accordance with the different authorization levels for use. A relationship between the setting data and the authorization levels for use will be specifically described.

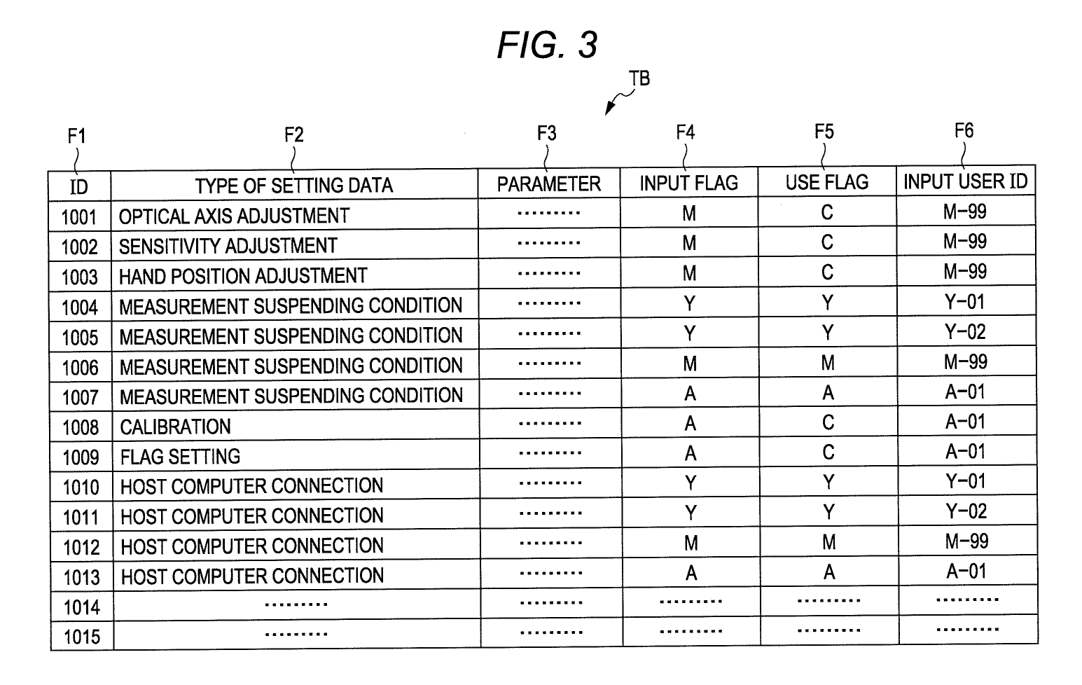

FIG. 3 is an example of a setting data table illustrating a relationship between setting data of the sample testing apparatus 1 according to the embodiment of the present invention and the authorization levels for use. As illustrated in FIG. 3, a setting data table TB includes an ID field F1 which shows IDs for identifying the setting data, a setting data type field F2 which stores therein types of the setting data, a parameter field F3 which stores therein parameters of the setting data, an input flag field F4 which stores therein flag information indicating which of the authorization levels for use authorizes input of the setting data, a use flag field F5 which stores therein flag information indicating which of the authorization levels for use is authorized to access the setting data, and an input user ID field F6 which stores therein the identification information of any operator who is authorized to input the setting data.

The ID field F1 stores therein IDs for identifying the different setting data.

The setting data type field F2 stores therein information indicating the type of the setting data such as “sensitivity adjustment” and “host computer connection”.

The parameter field F3 stores therein parameters of the different setting data. The parameters define, for example, specific numeral values and conditions of the setting data. When the setting data is inputted and received, the parameters are updated depending on the received input.

The input flag field F4 stores therein the flag information indicating which of the authorization levels for use authorizes input of each piece of setting data. More specifically, a flag “M” is affixed to the setting data which can be inputted by the serviceman authority, a flag “A” is affixed to the setting data which can be inputted by the administrator authority, and a flag “Y” is affixed to the setting data which can be inputted by the user authority.

The use flag field F5 stores therein the flag information indicating which of the authorization levels for use is authorized to access the setting data by each of the setting data (per ID). More specifically, a flag “M” is affixed to the setting data which is used by the serviceman authority during the apparatus operation, a flag “A” is affixed to the setting data which can be used by the administrator authority during the apparatus operation, a flag “Y” is affixed to the setting data which can be used by the user authority during the apparatus operation, and a flag “C” is affixed to the setting data used by all of the authorization levels for use, regardless of the authorization levels for use, during the apparatus operation.

The input user ID field F6 stores therein the identification information of any operator who can input the setting data. The operator's identification information is identification information (also called input user ID) inputted to the information processing device 5 along with a password in a login operation described later. The input user IDs illustrated in FIG. 3 are, “M-99” for identifying the operator in charge of maintenance, “A-01” for identifying the administrator, and “Y-01” and “Y-02” for identifying the operator who tests a sample.

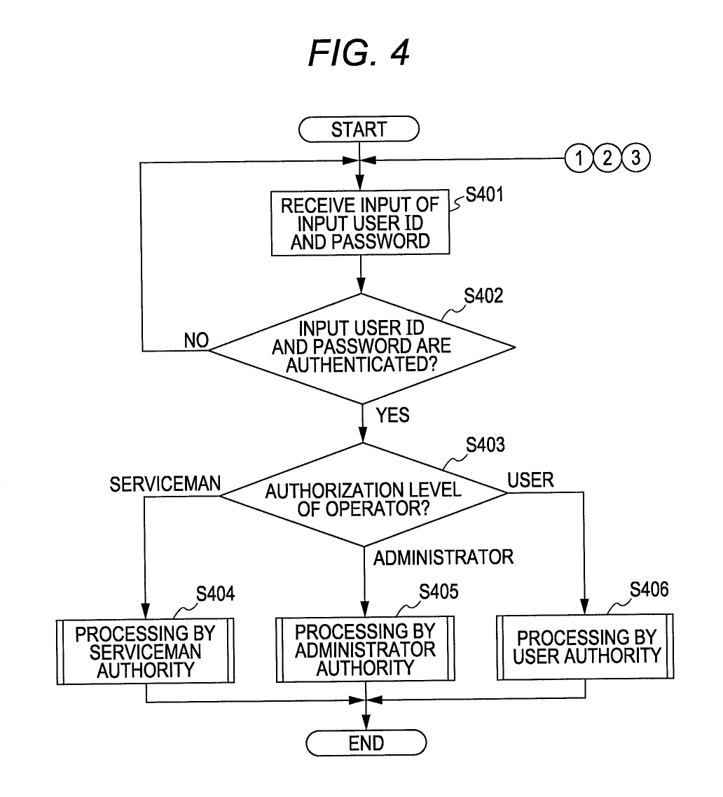

Hereinafter, the operation of the sample testing apparatus 1 according to the embodiment of the present invention will be described below. FIG. 4 is a flowchart illustrating processing steps by the controller 51 of the information processing device 5 in the sample testing apparatus 1 according to the embodiment of the present invention.

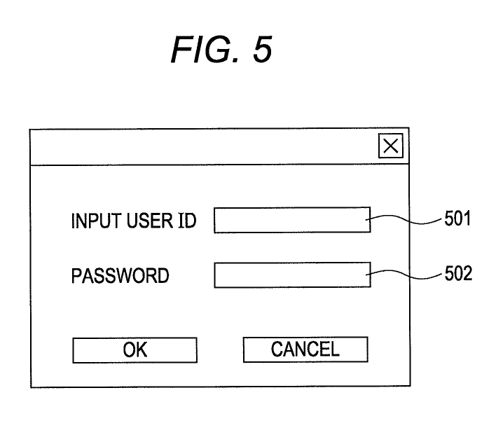

When the information processing device 5 of the sample testing apparatus 1 is turned on, the controller 51 of the information processing device 5 displays a login screen illustrated in FIG. 5 on the display unit 52 to receive the input user ID and password inputted thereto as the identification information which identifies the operator (step S401). FIG. 5 illustrates an example of the login screen displayed on the display unit 52 when the information processing device 5 of the sample testing apparatus 1 according to the embodiment of the present invention is turned on.

The operator inputs the input user ID which identifies the operator to an ID input region 501, and inputs the password which ensures security to a password input region 502. The identification information used to identify the operator is not necessarily inputted by and received from the operator as illustrated in FIG. 5. The operator may be automatically recognized by inserting, for example, a USB memory in which the input user ID and password are stored. Thus, as far as the input user ID and password which identify the operator are obtained, the ID and password can be received in different manners.

Returning to FIG. 4, the controller 51 of the information processing device 5 determines whether or not the received input user ID and password can be authenticated (step S402). When the controller 51 determines that the received input user ID and password cannot be authenticated (step S402: NO), the controller 51 returns to step S401 to wait for a different input user ID and password to be inputted.

When the controller 51 determines that the received input user ID and password can be authenticated (step S402: YES), the controller 51 consults the use authority information storage section 551 to determine whether the authorization level for use to which the received input user ID is entitled is the serviceman authority, administrator authority, or user authority (step S403). When the controller 51 determines that the authorization level for use to which the received input user ID is entitled is the serviceman authority, the controller 51 proceeds to step S404. When the controller 51 determines that the authorization level for use to which the received input user ID is entitled is the administrator authority, the controller 51 proceeds to step S405. When the controller 51 determines that the authorization level for use to which the received input user ID is entitled is the user authority, the controller 51 proceeds to step S406.

### [Processing by Serviceman Authority]

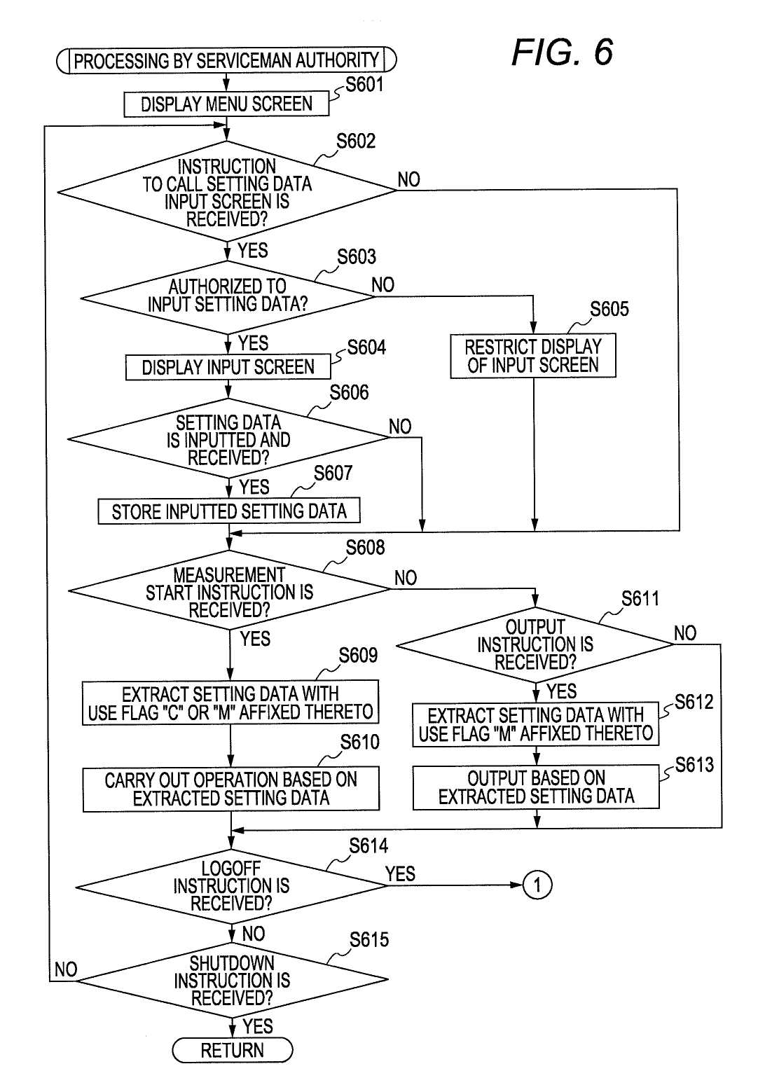

Next, processing steps of S404 illustrated in FIG. 4 will be described. FIG. 6 is a flowchart illustrating the processing steps in step S404 of FIG. 4 carried out by the controller 51 of the information processing device 5 in the sample testing apparatus 1 according to the embodiment of the present invention.

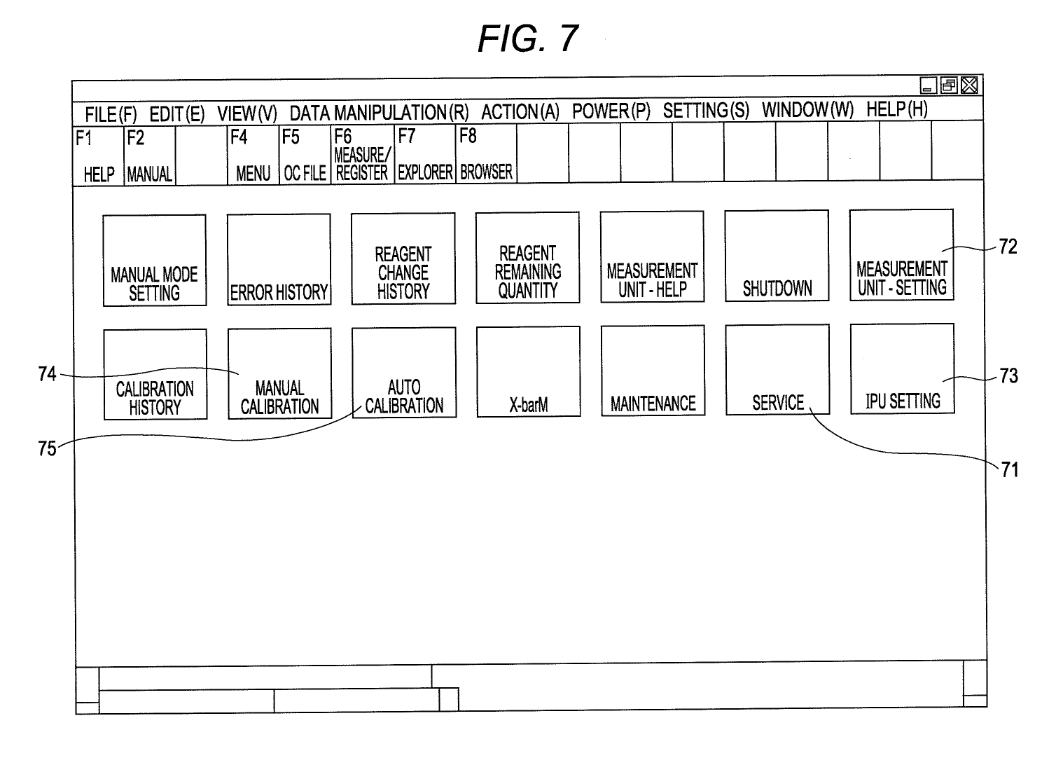

The controller 51 of the information processing device 5 displays a menu screen by the serviceman authority on the display unit 52 (step S601). FIG. 7 illustrates an example of the menu screen displayed on the display unit 52 by the serviceman authority. As illustrated in FIG. 7, the menu screen by the serviceman authority displays thereon icons for displaying an input screen where the setting data is inputted, for example, a service icon 71, a measurement unit setting icon 72, an IPU setting icon 73, a manual calibration icon 74, and an auto calibration icon 75. When the operator selects any desirable icon on the menu screen by manipulating the input unit 53 and presses an enter key or the like, the controller 51 receives an instruction to call the screen where the setting data corresponding to the selected icon is inputted.

The controller 51 determines whether or not the instruction to call the screen where the setting data is inputted is received (step S602). When the controller 51 determines that the screen call instruction was not received (step S602: NO), the controller 51 skips the processing steps of S603 to S607. When the controller 51 determines that the screen call instruction was received (step S602: YES), the controller 51 determines whether or not the operator is authorized to input the setting data which can be inputted to the called screen (step S603). More specifically, the controller 51 consults the setting data table TB to determine whether or not the input flag “M” is affixed to the setting data which can be inputted to the called screen. The controller 51 determines that the input flag “M” is affixed to the setting data and the operator is authorized to input the setting data, while determining that the operator is unauthorized to input the setting data if no input flag “M” is affixed thereto.

The controller 51, therefore, determines that the operator who is entitled to the serviceman authority is authorized to input the setting data, which are optical axis adjustment data (ID: 1001), sensitivity adjustment data (ID: 1002), hand position adjustment data (ID: 1003), measurement suspending condition data (ID: 1006), and host computer connection data (ID: 1012). When any of these setting data is inputted and received, the relevant setting data is thereby updated. On the other hand, the controller 51 determines that the operator is unauthorized to input the setting data with the flags other than the input flag “M” affixed thereto, such as calibration data (ID: 1008) and flag setting data (ID: 1009). When any of these setting data is inputted and received, the relevant setting data remains unchanged.

When the controller 51 determines that the operator is unauthorized to input the setting data (step S603: NO), the controller 51 displays a screen which cannot receive input of the setting data on the display unit 52 or ignores the call instruction (step S605), and then skips the processing steps of S604, S606, and S607. The controller 51 thus restricts the display of the input screen. When the controller 51 determines that the operator is authorized to input the setting data (step S603: YES), the controller 51 displays the screen which can receive input of the setting data on the display unit 52 (step S604). The controller 51 determines whether or not the setting data is inputted to the input screen (step S606). When the controller 51 determines that the setting data was not inputted (step S606: NO), the controller 51 skips the processing steps of S607. When the controller 51 determines that the setting data was inputted (step S606: YES), the controller 51 stores the inputted setting data (step S607).

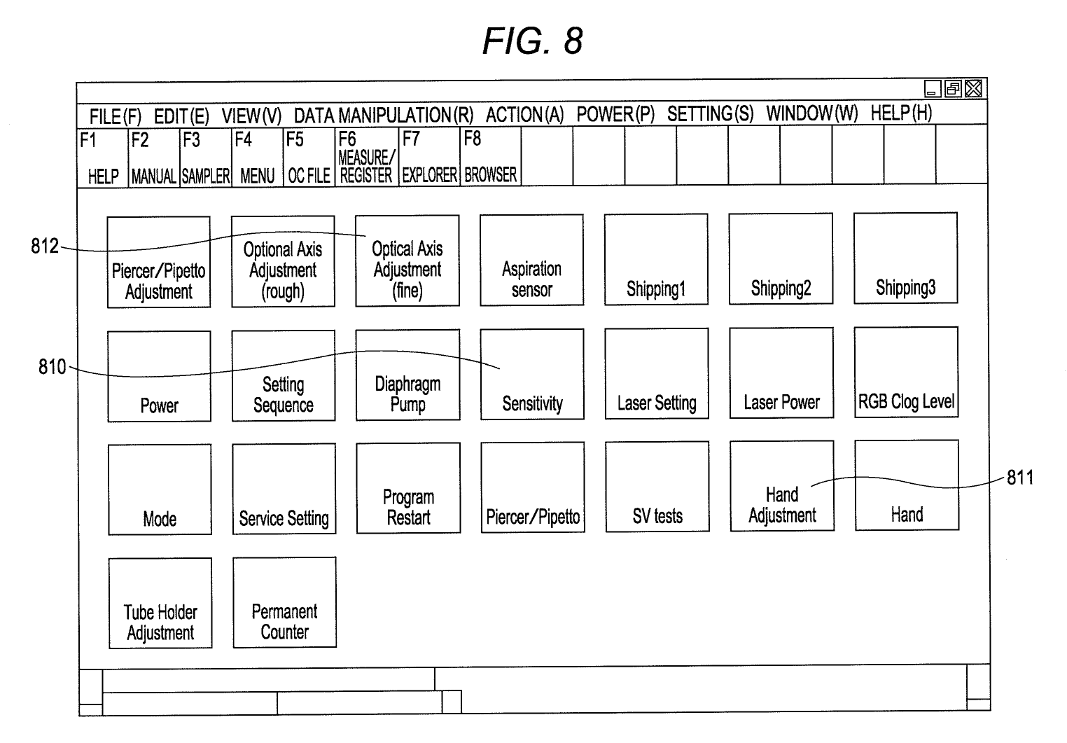

The above processing steps will be described in more detail with reference to the drawings. When the service icon 71 is selected by the operator on the menu screen illustrated in FIG. 7, a service menu screen illustrated in FIG. 8 is displayed on the display unit 52.

FIG. 8 illustrates an example of the service menu screen displayed on the display unit 52 when the service icon 71 illustrated in FIG. 7 is selected. The operator selects an icon indicating the desirable type of the setting data from icons displayed on the service menu screen. The controller 51 displays a screen for inputting and receiving the type of the setting data corresponding to the selected icon on the display unit 52. When, for example, a sensitivity icon 810, which is an icon used to call a screen for inputting and receiving the sensitivity adjustment data, is selected, the controller 51 displays the screen for inputting and receiving the sensitivity adjustment data on the display unit 52.

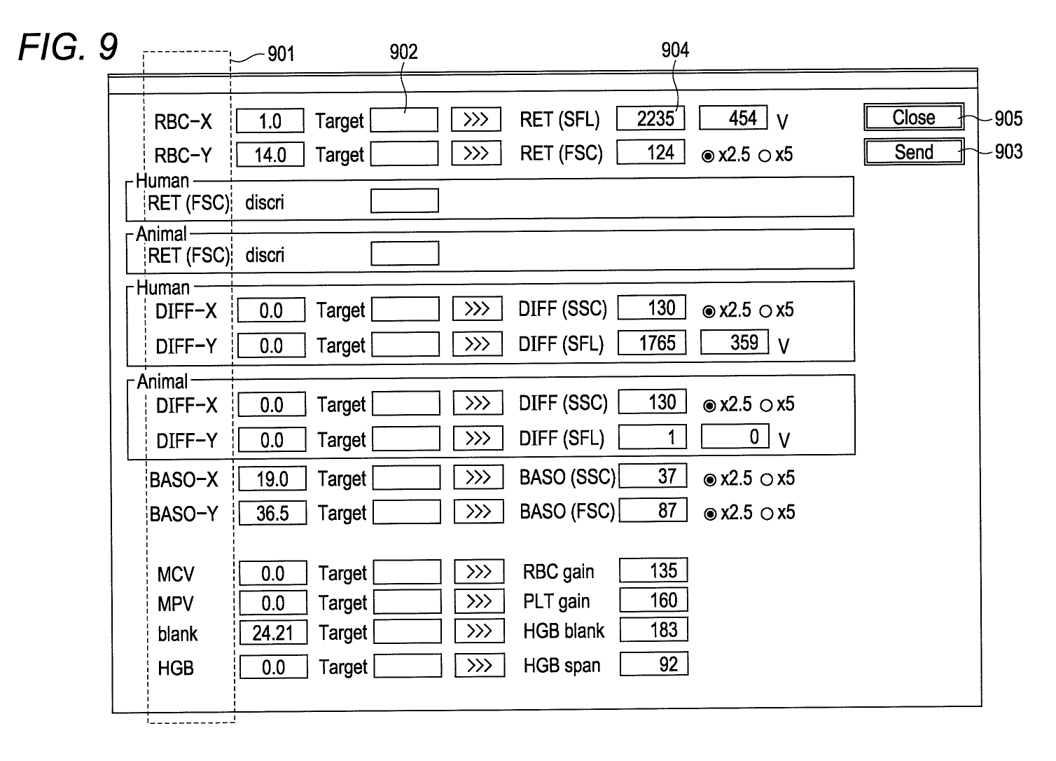

FIG. 9 illustrates an example of the screen for inputting the sensitivity adjustment data. The screen for inputting the sensitivity adjustment data displays thereon items 901 showing the setting data to be inputted, input boxes 902 for inputting sensitivity adjustment targeted values, a send button 903, display boxes 904 for displaying digital volume values, and a close button 905. The operator inputs a target value of the sensitivity adjustment to the input box 902 corresponding to a desired item of the items 901, and selects the send button 903. After the send button 903 is selected, the controller 51 calculates the digital volume value for adjusting the sensitivity to the inputted target value, and displays the calculated value in the display box 904. When the close button 905 is selected, the controller 51 updates the parameter of the sensitivity adjustment data (ID: 1002) in the setting data table TB depending on the calculated digital volume value.

When a hand adjustment icon 811, which is an icon for receiving the inputted hand position adjustment data, is selected on the service menu screen illustrated in FIG. 8, the controller 51 displays a screen for inputting the hand position adjustment data on the display unit 52, and updates the parameter of the hand position adjustment data (ID: 1003) in the setting data table TB depending on the received input.

When an optical axis adjustment icon 812, which is an icon for receiving the inputted optical axis adjustment data, is selected on the service menu screen illustrated in FIG. 8, the controller 51 displays a screen for inputting the optical axis adjustment data on the display unit 52, and updates the parameter of the optical axis adjustment data (ID: 1001) in the setting data table TB depending on the received input.

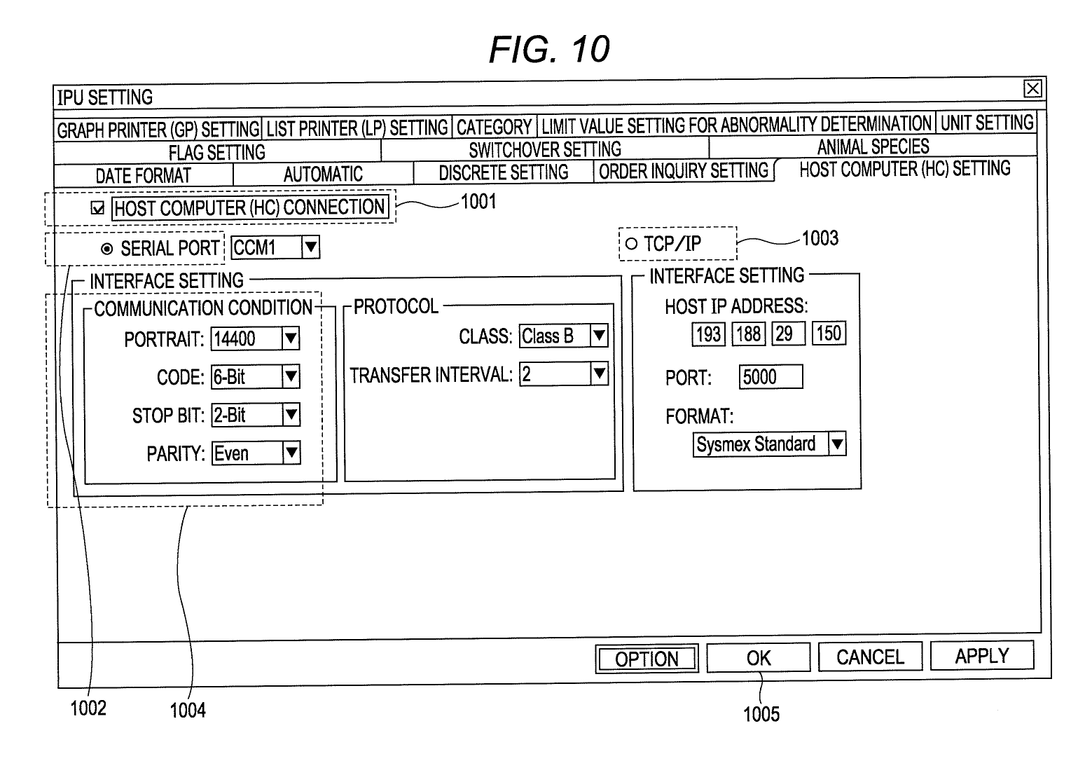

When the IPU setting icon 73 is selected by the operator on the menu screen illustrated in FIG. 7, the controller 51 displays an IPU setting screen illustrated in FIG. 10 on the display unit 52.

FIG. 10 illustrates an example of the IPU setting screen. As illustrated in FIG. 10, a plurality of tabs showing different types of the setting data are displayed in an upper part of the screen. The operator can call a screen for inputting and receiving the setting data of any desirable type by selecting one of the tabs. The example illustrated in FIG. 10 displays a screen for inputting the host computer connection data. The screen for inputting the host computer connection data displays thereon, for example, an input region 1001 for inputting whether there is connection with the host computer HC, an input region 1002 for inputting whether serial communication is performed, an input region 1003 for inputting whether there is TCP/IP connection, and an input region 1004 for inputting communication conditions in serial port connection.

When the operator connects the information processing device 5 to the host computer HC, the operator checks a checkbox in the input region 1001. When the operator chooses not to connect the information processing device 5 to the host computer HC, the operator unchecks the checkbox in the input region 1001. When the operator performs serial communication between the information processing device 5 and the host computer HC, the operator checks a radio button in the input region 1002. When the operator builds TCP/IP connection between the information processing device 5 and the host computer HC, the operator checks a radio button in the input region 1003.

When the operator performs serial communication between the information processing device 5 and the host computer HC, the operator can input a plurality of communication conditions. More specifically, the operator can input data to the sections of “baudrate”, “code”, “stop bit”, and “parity” displayed in the input region 1004. The operator selects a pull-down button for each of the communication conditions to input any desirable communication conditions. A transfer speed can be inputted to the “baudrate”, a data bit length can be inputted to the “code”, a stop bit length can be inputted to the “stop bit”, and a parity check method (None/Even/Odd) can be inputted to the “parity”.

When the operator selects an OK button 1005 displayed in a lower part of the screen after the operator inputs the communication conditions, the controller 51 extracts the inputted communication conditions, and updates the parameter of the host computer connection data (ID: 1012) in the setting data table TB depending on the extracted communication conditions.

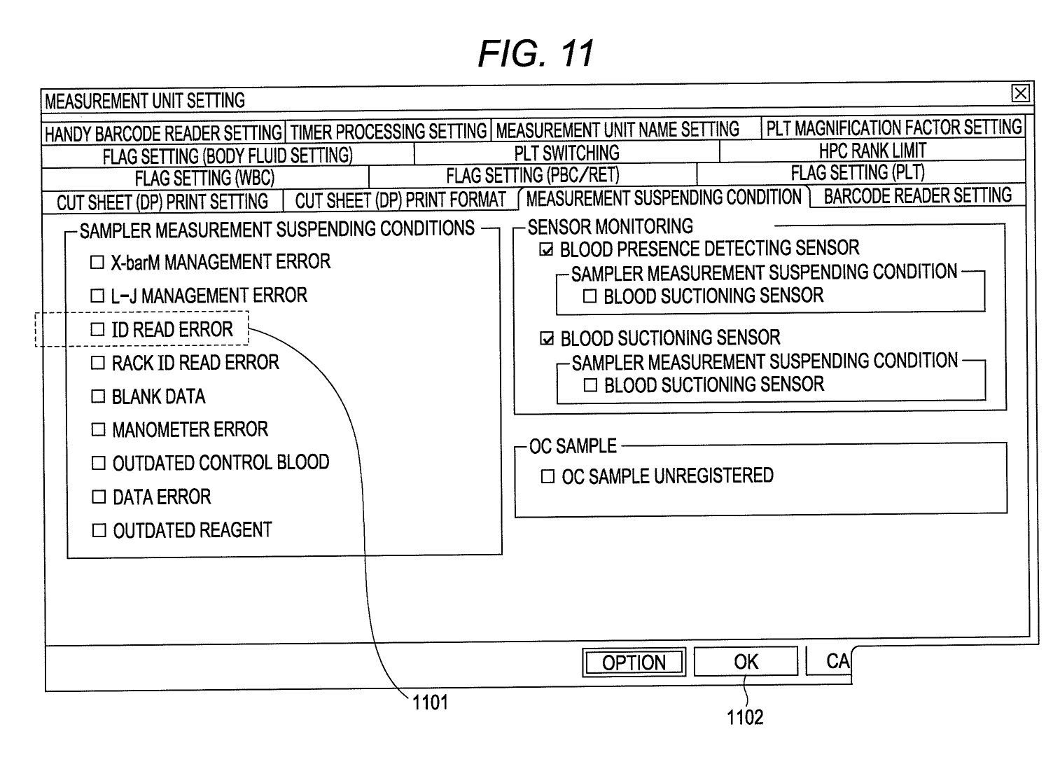

When the operator selects the measurement unit setting icon 72 on the menu screen illustrated in FIG. 7, the controller 51 displays a measurement unit setting screen illustrated in FIG. 11 on the display unit 52.

FIG. 11 illustrates an example of the measurement unit setting screen. As illustrated in FIG. 11, a plurality of tabs showing different types of the setting data are displayed in an upper part of the screen. The operator can call a screen for inputting and receiving the setting data of any desirable type by selecting one of the tabs. The example illustrated in FIG. 11 displays a screen for inputting the measurement suspending condition data. The screen for inputting the measurement suspending condition data displays thereon measurement suspending conditions and checkboxes corresponding to the conditions. For example, in FIG. 11, “ID read error” as a measurement suspending condition and its checkbox are illustrated in a region 1101. When the operator suspends the measuring operation in response to the occurrence of an ID read error, the operator checks the checkbox. When the operator does not want to suspend the measurement regardless of the ID read error, the operator unchecks the checkbox. The operator selects an OK button 1102 displayed in a lower part of the screen after the measurement suspending condition is inputted. When the OK button 1102 is selected, the controller 51 extracts the condition whose checkbox is checked as the measurement suspending condition, and updates the parameter of the measurement suspending condition data (ID: 1006) in the setting data table TB depending on the extracted measurement suspending condition.

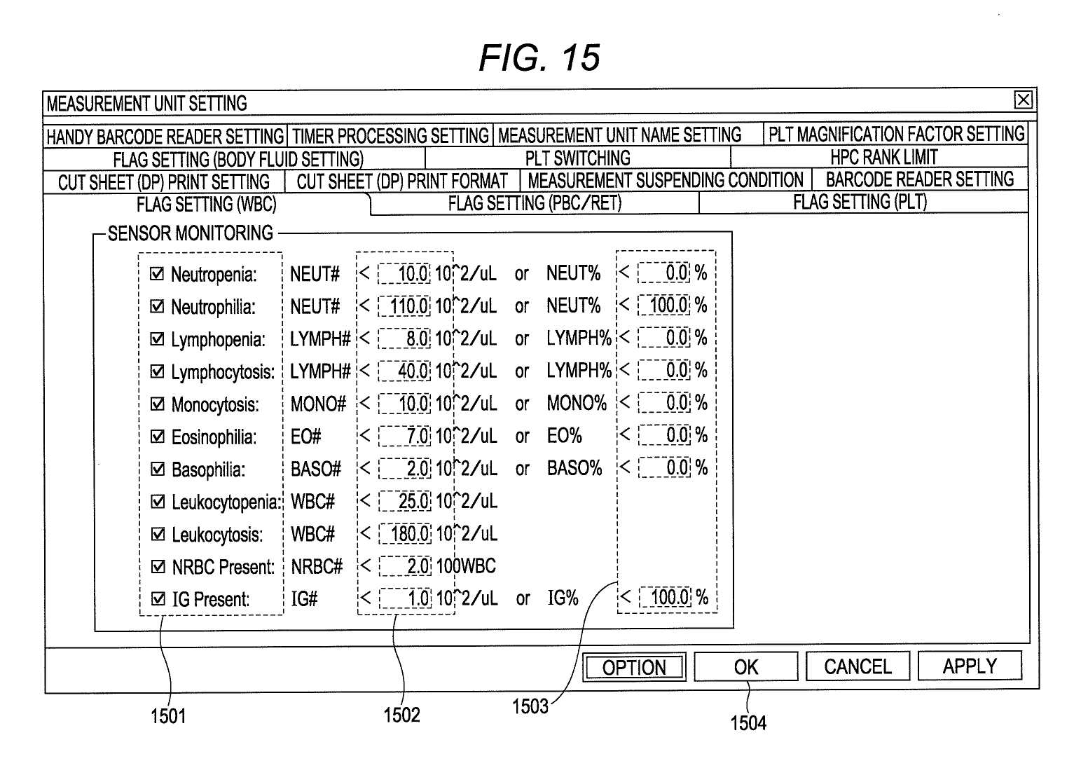

When the operator selects a “flag setting (WBC)” tab on the input screen illustrated in FIG. 11, the display unit 52 displays thereon such a screen for inputting the flag setting data as illustrated in FIG. 15. As described earlier, the operator who is entitled to the serviceman authority is unauthorized to input the flag setting data. Therefore, checkboxes and input boxes for inputting numeral values are displayed in gray to notify that these boxes do not accept any inputs. Thus, the operator who is entitled to the serviceman authority is unable to change the flag setting data (ID: 1009).

The menu screen illustrated in FIG. 7 displays thereon the manual calibration icon 74 and the auto calibration icon 75 for inputting the calibration data (ID: 1008). However, these icons are inactivated so that the operator who is entitled to the serviceman authority is unable to select these icons. Therefore, an instruction to call a calibration data setting screen issued by the operator is ignored, and the operator who is entitled to the serviceman authority is unable to input the calibration data (ID: 1008).

Returning to FIG. 6, the controller 51 of the information processing device 5 determines whether or not the measurement start instruction is received (step S608). When the controller 51 determines that the measurement start instruction was received (step S608: YES), the controller 51 consults the setting data table TB to extract the setting data with the use flag “C” or “M” affixed thereto (step S609). In the example illustrated in FIG. 3, the setting data to be extracted are the optical axis adjustment data (ID: 1001), sensitivity adjustment data (ID: 1002), hand position adjustment data (ID: 1003), measurement suspending condition data (ID: 1006), calibration data (ID: 1008), flag setting data (ID: 1009), and host computer connection data (ID: 1012). The controller 51 carries out the operation of the apparatus based on the extracted setting data (step S610).

More specifically, the controller 51 transmits the extracted optical axis adjustment data (ID: 1001), sensitivity adjustment data (ID: 1002), hand position adjustment data (ID: 1003), and measurement suspending condition data (ID: 1006) to the measurement unit 3. The measurement unit 3 moves the hand portion upward and downward based on the transmitted hand position adjustment data (ID: 1003), and grabs the sample container 100 using the hand portion from the sample rack 101 transversely transferred by the sampler 4 and introduces the sample container 100 into the apparatus. The measurement unit 3 then mixes the blood sample contained in the sample container 100 with a reagent to prepare a measurement specimen, and pours the prepared measurement specimen into a flow cell.

Based on the optical axis adjustment data (ID: 1001), the measurement unit 3 controls the light source so that the measurement specimen flowing in the flow cell is irradiated with light along the adjusted optical axis. When the measurement specimen flowing in the flow cell is irradiated with the light, the light receiving section receives light generated by the light irradiated thereon and outputs a signal based on a quantity of the received light. The signal outputted from the light receiving section is amplified in accordance with a gain adjusted by the sensitivity adjustment data (ID: 1002). The measurement unit 3 transmits the amplified signal to the information processing device 5 as measurement data. During these measuring operations, the measurement unit 3 monitors whether or not an event that matches any of the conditions included in the measurement suspending condition data (ID: 1006) has occurred. For example, when the operator checks the checkbox of “ID read error” displayed in the region 1101 on the screen illustrated in FIG. 11, the measurement unit 3 monitors whether or not the ID read error occurs. In response to the occurrence of the ID read error, the measurement unit 3 suspends the measuring operation.

When the controller 51 of the information processing device 5 receives the measurement data, the controller 51 analyzes the received measurement data based on the calibration data (ID: 1008) to generate an analysis result. The controller 51 determines whether or not the generated analysis result matches any of the conditions included in the flag setting data (ID: 1009). When it is determined that the generated analysis result matches any of the conditions included in the flag setting data, the controller 51 displays the generated analysis result with the flag affixed thereto on the display unit 52.

Returning to FIG. 6, when the controller 51 of the information processing device 5 determines that the measurement start instruction was not received (step S608: NO), the controller 51 determines whether or not an output instruction is received (step S611). In the present embodiment, for example, it is determined whether or not an instruction to output the analysis result to the host computer HC is issued. When the controller 51 determines that the output instruction was not received (step S611: NO), the controller 51 skips the processing steps of S612 and S613. When the controller 51 determines that the output instruction was received (step S611: YES), the controller 51 extracts setting data relating to the output instruction, which is the setting data with the use flag “M” affixed thereto (step S612). In the present embodiment, for example, the host computer connection data (ID: 1012) is extracted. The controller 51 outputs the analysis result to the host computer HC in accordance with the condition based on the extracted host computer connection data (ID: 1012) (step S613).

When the processing steps are completed, the controller 51 then determines whether or not a logoff instruction is received (step S614). When the controller 51 determines that the logoff instruction was received (step S614: YES), the controller 51 returns to the processing step of S401 illustrated in FIG. 4. When the controller 51 determines that the logoff instruction was not received (step S614: NO), the controller 51 determines whether or not a shutdown instruction is received (step S615). When the controller 51 determines that the shutdown instruction was not received (step S615: NO), the controller 51 returns to the processing step of S602 to repeat the processing steps described above. When the controller 51 determines that the shutdown instruction was received (step S615: YES), the controller 51 ends the processing steps to return to the operation illustrated in FIG. 4.

### [Processing by Administrator Authority]

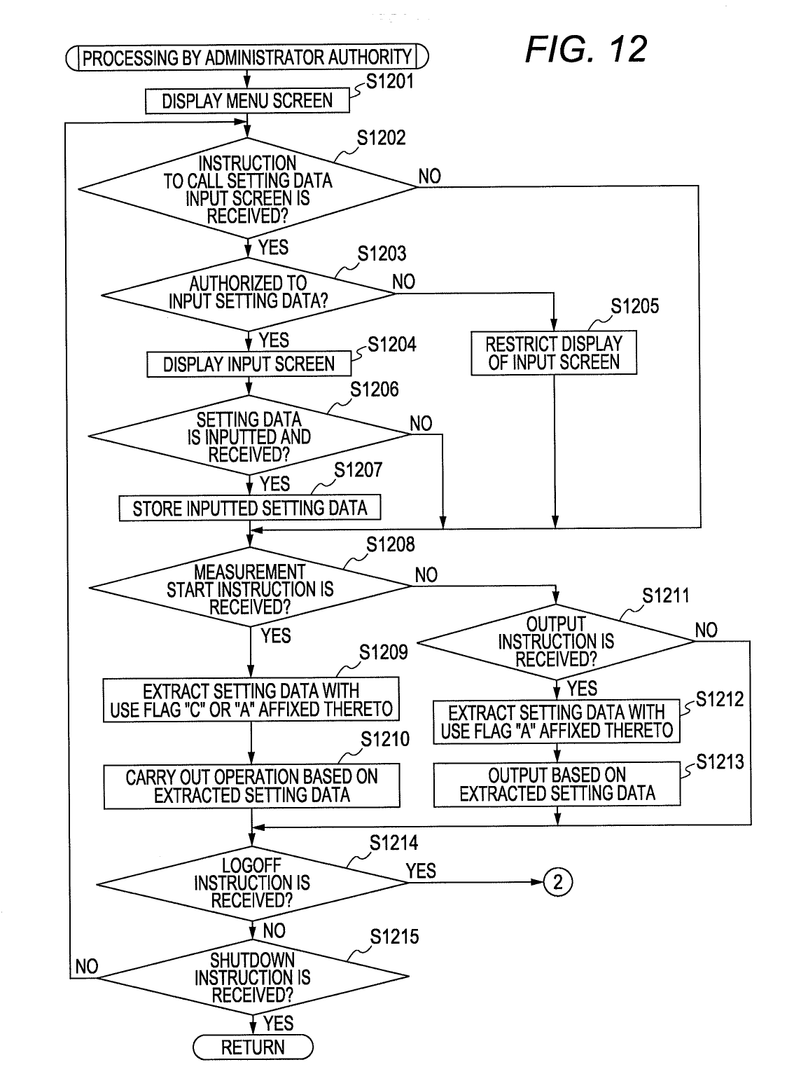

Next, processing steps of S405 illustrated in FIG. 4 will be described. FIG. 12 is a flowchart illustrating processing steps in step S405 of FIG. 4 carried out by the controller 51 of the information processing device 5 in the sample testing apparatus 1 according to the embodiment of the present invention.

The flowchart illustrating the processing steps by the administrator authority is substantially the same as the flowchart illustrating the processing steps by the serviceman authority. Therefore, only the processing steps different from the processing steps by the serviceman authority will be described below, while description of any overlapping steps will not be given.

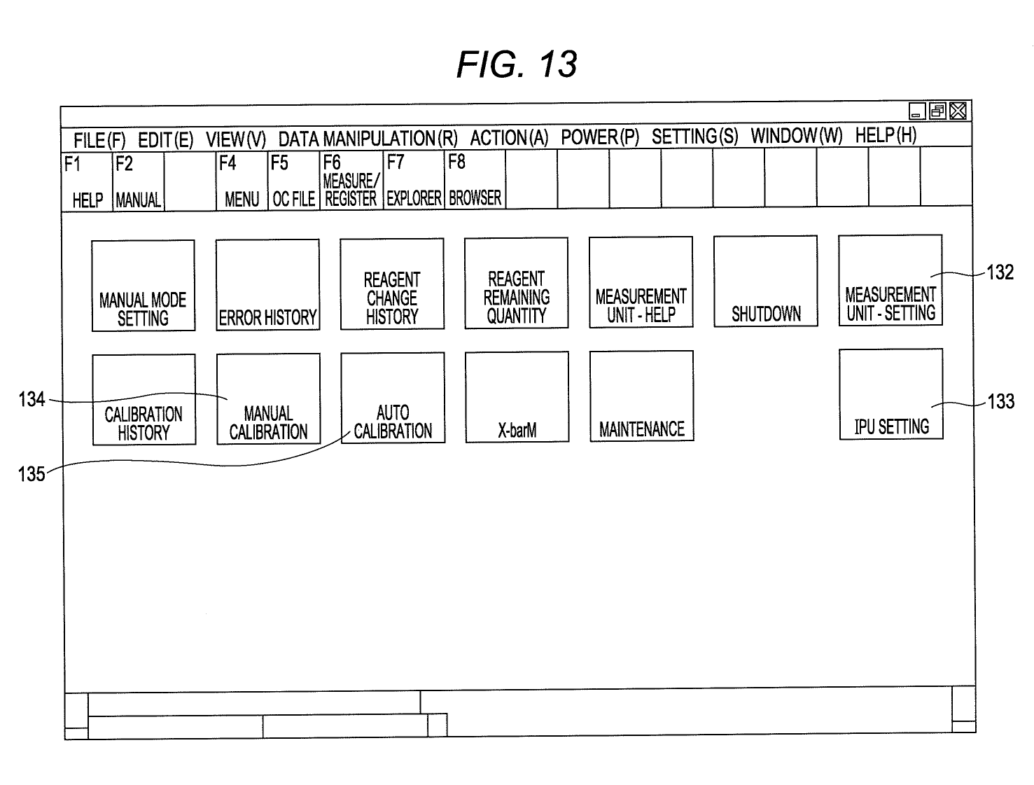

In FIG. 12, the controller 51 of the information processing device 5 displays a menu screen by the administrator authority on the display unit 52 (step S1201). FIG. 13 illustrates an example of the menu screen displayed on the display unit 52 by the administrator authority. The menu screen displayed by the administrator authority is substantially the same as the menu screen displayed by the serviceman authority (see FIG. 7), except that the service icon 71 is not displayed. Therefore, the administrator authority is not allowed to call the service menu screen described earlier (see FIG. 8). Needless to say, the administrator authority is thus unable to call the screen for inputting the setting data such as sensitivity adjustment data and optical axis adjustment data. Therefore, the operator who is entitled to the administrator authority is unable to input the setting data such as sensitivity adjustment data. Accordingly, without determining the authorization level for inputting the setting data in step S1203 described later, the administrator authority is not authorized to input the setting data such as sensitivity adjustment data.

The controller 51 determines whether or not the screen call instruction where the setting data is inputted is received (step S1202). When the controller 51 determines that the screen call instruction was not received (step S1202: NO), the controller 51 skips the processing steps of S1203 to 1207. When the controller 51 determines that the screen call instruction was received (step S1202: YES), the controller 51 determines whether or not it is authorized to input the setting data which can be inputted to the called screen (step S1203). More specifically, the controller 51 consults the setting data table TB to determine whether or not the input flag “A” is affixed to the setting data which can be inputted to the called screen. The controller 51 determines that it is authorized to input the setting data with the input flag “A” affixed thereto, while determining it is unauthorized to input the setting data with no input flag “A” affixed thereto.

Therefore, the operator who is entitled to the administrator authority is determined as authorized to input the setting data such as measurement suspending condition data (ID: 1007), calibration data (ID: 1008), flag setting data (ID: 1009), and host computer connection data (ID: 1013). Accordingly, the operator can input these setting data. The operator is, however, determined as unauthorized to input the setting data with any input flag other than the “A”, affixed thereto such as optical axis adjustment data (ID: 1001), sensitivity adjustment data (ID: 1002), and hand position adjustment data (ID: 1003). Accordingly, the operator is unable to input these setting data.

When the controller 51 determines that it is unauthorized to input the setting data (step S1203: NO), the controller 51 displays a screen which rejects input of the setting data on the display unit 52 or ignores the call instruction (step S1205), and then skips the processing steps of S1204, S1206, and S1207. The controller 51 thus restricts the display of the input screen. When the controller 51 determines that it is authorized to input the setting data (step S1203: YES), the controller 51 displays a screen where the setting data can be inputted on the display unit 52 (step S1204). The controller 51 determines whether or not the setting data is inputted to the input screen where the setting data can be inputted (step S1206). When the controller 51 determines that the setting data was not inputted (step S1206: NO), the controller 51 skips the processing step of S1207. When the controller 51 determines that the setting data was inputted (step S1206: YES), the controller 51 stores the inputted setting data (step S1207).

The above processing steps will be described in more detail with reference to the drawings. When an IPU setting icon 133 is selected by the operator on the menu screen illustrated in FIG. 13, the screen for inputting the host computer connection data illustrated in FIG. 10 is displayed on the display unit 52. When the OK button 1005 is selected after the operator inputs the setting data, the controller 51 extracts the inputted setting data, and updates the parameter of the host computer connection data (ID: 1013) in the setting data table TB.

Further, the operator can select a measurement unit setting icon 132 on the menu screen illustrated in FIG. 13 in a manner similar to the serviceman authority. By selecting the measurement unit setting icon 132, the operator can call a screen for inputting measurement suspending condition data illustrated in FIG. 11 to input the setting data thereto. When the setting data is inputted and the OK button 1102 is then selected, the controller 51 extracts the inputted setting data, and updates the parameter of the measurement suspending condition data (ID: 1007) in the setting data table TB.

When the measurement unit setting icon 132 is selected by the administrator authority, and a “flag setting (WBC)” tab is selected on the measurement unit setting screen illustrated in FIG. 11, a screen for inputting the flag setting data illustrated in FIG. 15 is displayed on the display unit 52.

FIG. 15 illustrates an example of the screen for inputting the flag setting data. The flag setting screen mainly displays thereon, for example, an input region 1501 showing WBC subclass items to be flagged and their checkboxes, an input region 1502 for inputting conditions relating to count values, and an input region 1503 for inputting conditions relating to subclass ratios.

The operator selects, from the plurality of items displayed in the input region 1501, the WBC subclass item to be flagged, and checks the checkbox of the selected subclass. Further, the operator inputs the count value-related conditions to the input region 1502 and the ratio-related conditions to the input region 1503, and then selects an OK button 1504 displayed in a lower part of the screen. When the OK button 1504 is selected, the controller 51 extracts the inputted setting data, and updates the parameter of the flag setting data (ID: 1009) in the setting data table TB.

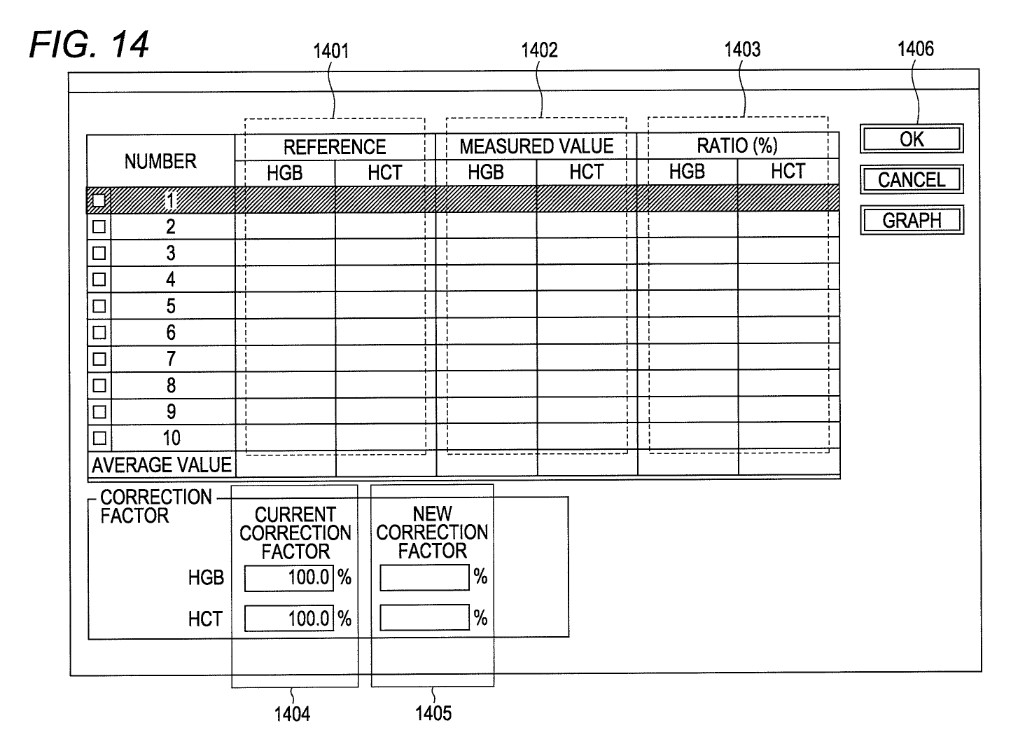

The administrator authority further empowers the operator to input the calibration data. As illustrated in the menu screen of FIG. 13, the menu screen by the administrator authority displays thereon a manual calibration icon 134 and an auto calibration icon 135. On the menu screen displayed by the serviceman authority (see FIG. 7), these icons are just displayed and are inactivated so that they cannot be selected. On the other hand, these icons are activated on the menu screen displayed by the administrator authority so that they can be selected by the operator. Therefore, the operator who is entitled to the administrator authority can call the screen for inputting the calibration data and input the calibration data thereto by selecting the manual calibration icon 134 or the auto calibration icon 135. Here, a case where the auto calibration icon 135 is selected will be described. When the auto calibration icon 135 is selected, the controller 51 displays the input screen for receiving the calibration data illustrated in FIG. 14 on the display unit 52.

FIG. 14 illustrates an example of the screen for inputting the calibration data. As illustrated in FIG. 14, the screen for inputting the calibration data mainly displays thereon a reference value input region 1401 for inputting reference values, a measurement value display region 1402 for displaying measurement values, a ratio display region 1403 for displaying ratios of the measurement values with the reference values, a current correction factor display region 1404 for displaying current correction factors, and a new correction factor display region 1405 for displaying new correction factors.

The operator inputs a value obtained by separately measuring a sample for calibration to the reference value input region 1401 as a reference value. Then, the operator measures the sample for calibration using the sample testing apparatus 1. The controller 51 displays measurement data obtained by measuring the sample for calibration in the measurement value display region 1402. The controller 51 calculates a ratio of the measurement value with the reference value, and displays the calculated ratio in the radio display region 1403. The operator repeatedly performs the steps described above for a plurality of samples for calibration.

The controller 51 calculates an average value x % of the ratios obtained from the plurality of samples for calibration to calculate a correction factor for correcting the calculated ratio average value x % to 100%. The controller 51 displays the calculated correction factor in the new correction factor display region 1405. The operator selects an OK button 1406 when he wants to update the current correction factor displayed in the current correction ratio display region 1404 to a new correction factor. When the controller 51 selects the OK button 1406, the controller 51 updates the parameter of the calibration data (ID: 1008) in the setting data table TB to a parameter suitable for the new correction factor.

Returning to FIG. 12, the controller 51 of the information processing device 5 determines whether or not the measurement start instruction is received (step S1208). When the controller 51 determines that the measurement start instruction was received (step S1208: YES), the controller 51 consults the setting data table TB to extract the setting data with the use flag “C” or “A” affixed thereto (step S1209). The setting data extracted in the example illustrated in FIG. 3 are optical axis adjustment data (ID: 1001), sensitivity adjustment data (ID: 1002), hand position adjustment data (ID: 1003), measurement suspending condition data (ID: 1007), calibration data (ID: 1008), flag setting data (ID: 1009), and host computer connection data (ID: 1013). The controller 51 carries out the operation of the apparatus based on the extracted setting data (step S1210).

The operation described below is substantially the same as the operation by the serviceman authority described earlier, and description of details thereof will not be given.

When the controller 51 determines that the measurement start instruction was not received (step S1208: NO), the controller 51 determines whether or not the output instruction is received (step S1211). In the present embodiment, for example, it is determined whether or not the instruction to output the analysis result to the host computer HC is issued. When the controller 51 determines that the output instruction was not received (step S1211: NO), the controller 51 skips the processing steps of S1212 and S1213. When the controller 51 determines that the output instruction was received (step S1211: YES), the controller 51 extracts the setting data relating to the output instruction, which is the setting data with the use flag “A” affixed thereto (step S1212). In the present embodiment, for example, the host computer connection data (ID: 1013) is extracted. The controller 51 outputs the analysis result to the host computer HC in accordance with the condition based on the extracted host computer connection data (ID: 1013) (step S1213).

When the processing steps are completed, the controller 51 determines whether or not the logoff instruction is received (step S1214). When the controller 51 determines that the logoff instruction was received (step S1214: YES), the controller 51 returns to the processing step of S401 illustrated in FIG. 4. When the controller 51 determines that the logoff instruction was not received (step S1214: NO), the controller 51 determines whether or not the shutdown instruction is received (step S1215). When the controller 51 determines that the shutdown instruction was not received (step S1215: NO), the controller 51 returns to the processing step of S1202 to repeat the processing steps described above. When the controller 51 determines that the shutdown instruction was received (step S1215: YES), the controller 51 ends the processing steps to return to the operation illustrated in FIG. 4.

### [Processing by User Authority]

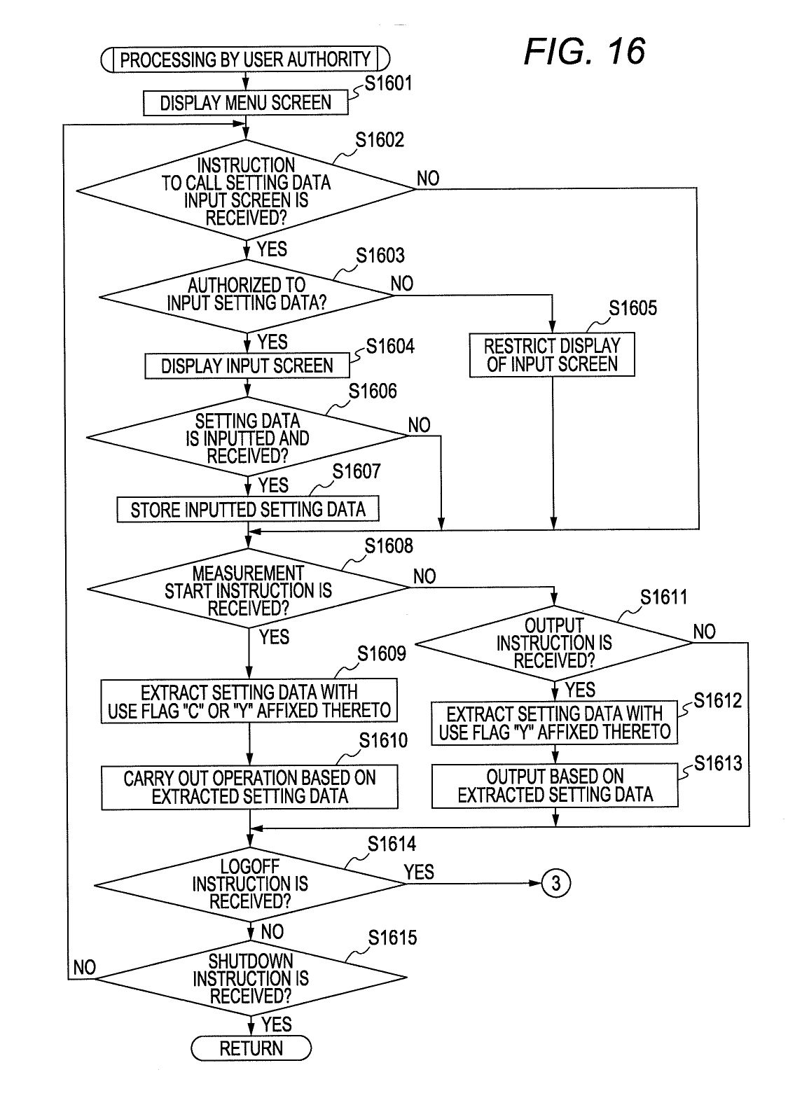

Next, processing steps of S406 illustrated in FIG. 4 will be described. FIG. 16 is a flowchart illustrating processing steps in step S406 of FIG. 4 carried out by the controller 51 of the information processing device 5 in the sample testing apparatus 1 according to the embodiment of the present invention.

The flowchart illustrating the processing steps by the user authority is substantially the same as the flowchart illustrating the processing steps by the serviceman authority. Therefore, only the processing steps different from the processing steps by the serviceman authority will be described below, while description of any overlapping steps will not be given.

In FIG. 16, the controller 51 of the information processing device 5 displays a menu screen by the user authority on the display unit 52 (step S1601). The menu screen displayed on the display unit 52 by the user authority is substantially the same as the menu screen displayed by the administrator authority (see FIG. 13), except that the service icon is not displayed. Therefore, the user authority is not allowed to call the service menu screen described earlier (see FIG. 8). Needless to say, the user authority is unable to call the screen for inputting the setting data such as sensitivity adjustment data and optical axis adjustment data. Therefore, the operator who is entitled to the user authority is unable to input the setting data such as sensitivity adjustment data. Without determining the authorization level for inputting the setting data in step S1603 described later, the user authority is not authorized to input the setting data such as sensitivity adjustment data.

The controller 51 determines whether or not the instruction to call the screen where the setting data is inputted is received (step S1602). When the controller 51 determines that the instruction to call the screen was not received (step S1602: NO), the controller 51 skips the processing steps of S1603 to S1607. When the controller 51 determines that the instruction to call the screen was received (step S1602: YES), the controller 51 determines whether or not it is authorized to input the setting data which can be inputted and received on the called screen (step S1603). More specifically, the controller 51 consults the setting data table TB to determine whether or not the input flag “Y” is affixed to the setting data which can be inputted and received on the called screen. The controller 51 determines that it is authorized to input the setting data when the input flag “Y” is affixed thereto, while determining it is unauthorized to input the setting data with no input flag “Y” affixed thereto.

The operator who is entitled to the user authority is determined as authorized to input the setting data, which are measurement suspending condition data (ID: 1004, 1005), and host computer connection data (ID: 1010, 1011). Accordingly, the operator can input these setting data. The operator is, however, determined as unauthorized to input the setting data with any input flag other than the “Y” affixed thereto such as optical axis adjustment data (ID: 1001), sensitivity adjustment data (ID: 1002), and hand position adjustment data (ID: 1003), calibration data (ID: 1008), and flag setting data (ID: 1009). Accordingly, the operator cannot input these setting data.

When the controller 51 determines that input of the setting data is unauthorized (step S1603: NO), the controller 51 displays a screen which rejects input of the setting data on the display unit 52 or ignores the call instruction (step S1605), and then skips the processing steps of S1604, S1606 and S1607. The controller 51 thus restricts the display of the input screen. When the controller 51 determines that input of the setting data is authorized (step S1603: YES), the controller 51 displays a screen which can receive input of the setting data on the display unit 52 (step S1604). The controller 51 determines whether or not the setting data is inputted and received on the input screen to which the setting data can be inputted and received (step S1606). When the controller 51 determines that the setting data was not inputted (step S1606: NO), the controller 51 skips the processing steps of S1607. When the controller 51 determines that the setting data was inputted (step S1606: YES), the controller 51 stores the inputted setting data (step S1607).

In the case where Y-01 is inputted as the input user ID at the time of login, step S1607 updates the setting data in which “Y-01” is stored in the input user ID field F6 of the setting data table TB. Similarly, in the case where Y-02 is inputted as the input user ID at the time of login, step S1607 updates the setting data in which “Y-02” is stored in the input user ID field F6.

The processing steps will be described in more detail with reference to the drawings. When an IPU setting icon 133 is selected by the operator on the menu screen illustrated in FIG. 13, the controller 51 displays the screen for inputting the host computer connection data illustrated in FIG. 10 on the display unit 52. When the operator selects the OK button 1005 after he inputs the setting data, the controller 51 extracts the inputted setting data, and updates the parameter of the host computer connection data corresponding to the input user ID inputted at the time of login. More specifically, in the case where Y-01 is inputted as the input user ID at the time of login, the parameter of the host computer connection data (ID: 1010) is updated. In the case where Y-02 is inputted as the input user ID at the time of login, the parameter of the host computer connection data (ID: 1011) is updated.

Further, the operator can select the measurement unit setting icon 132 in a manner similar to the serviceman authority on the menu screen illustrated in FIG. 13. By selecting the measurement unit setting icon 132, the operator can call the screen for inputting the measurement suspending condition data illustrated in FIG. 11 to input the setting data thereto. When the operator selects an OK button 1102 after he inputs the setting data, the controller 51 extracts the inputted setting data, and updates the parameter of the measurement suspending condition data corresponding to the input user ID inputted at the time of login. More specifically, in the case where Y-01 is inputted as the input user ID at the time of login, the parameter of the measurement suspending condition data (ID: 1004) is updated. In the case where Y-02 is inputted as the input user ID at the time of login, the parameter of the measurement suspending condition data (ID: 1005) is updated.

For the operator who is entitled to the user authority, the menu screen illustrated in FIG. 13 similarly displays thereon the manual calibration icon 134 and the auto calibration icon 135. However, these icons are inactivated so that the operator who is entitled to the user authority is unable to select these icons. Therefore, the operator who is entitled to the user authority is unable to input the calibration data similarly to the operator who is entitled to the serviceman authority.

When the measurement unit setting icon 132 is selected by the operator on the menu screen illustrated in FIG. 13, and the “flag setting (WBC) tab” is selected by the operator on the input screen illustrated in FIG. 11, the input screen which receives input of the flag setting data illustrated in FIG. 15 is displayed on the display unit 52. However, numeral value input boxes and their checkboxes are displayed in gray and are inactivated so that they are not selectable and do not accept any inputs. Thus, the user authority is unauthorized to input the flag setting data.

Returning to FIG. 16, the controller 51 of the information processing device 5 determines whether or not the measurement start instruction is received (step S1608). When the controller 51 determines that the measurement start instruction was received (step S1608: YES), the controller 51 consults the setting data table TB to extract the setting data with the flag “C” or “Y” affixed thereto (step S1609). In the case where Y-01 is inputted as the input user ID at the time of login, the setting data in which “Y-01” is stored as the input user ID is extracted among all of the pieces of setting data with the use flag “Y” affixed thereto. In the case where Y-02 is inputted as the input user ID at the time of login, the setting data in which “Y-02” is stored as the input user ID is extracted among all of the pieces of setting data with the use flag “Y” affixed thereto.

Therefore, when Y-01 is inputted as the input user ID at the time of login, and the measurement start instruction is then received, the setting data such as optical axis adjustment data (ID: 1001), sensitivity adjustment data (ID: 1002), hand position adjustment data (ID: 1003), measurement suspending condition data (ID: 1004), calibration data (ID: 1008), and flag setting data (ID: 1009) are extracted from the setting data table TB. On the other hand, when Y-02 is inputted as the input user ID at the time of login, and the measurement start instruction is then received, the setting data of the measurement suspending condition data (ID: 1005) is extracted among all of the pieces of setting data in place of the measurement suspending condition data (ID: 1004). The controller 51 carries out the operation of the apparatus based on the extracted setting data (step S1610).

The operation is substantially the same as the operation by the serviceman authority described earlier, and detailed description thereof will not be given.

When the controller 51 determines that the measurement start instruction was not received (step S1608: NO), the controller 51 determines whether or not the output instruction is received (step S1611). In the present embodiment, for example, it is determined whether or not the instruction to output the analysis result to the host computer HC is issued. When the controller 51 determines that the output instruction was not received (step S1611: NO), the controller 51 skips the processing steps of S1612 and S1613. When the controller 51 determines that the output instruction was received (step S1611: YES), the controller 51 extracts the setting data relating to the output instruction, which is the setting data with the use flag “Y” affixed thereto (step S1612).

When the output instruction is issued by the operator identified by the input user ID, Y-01, similarly to the processing in response to the measurement start instruction, the setting data in which “Y-01” is stored as the input user ID is extracted among all of the pieces of setting data with the use flag, “Y”, affixed thereto. When the output instruction is issued by the operator identified by the input user ID, Y-02, the setting data in which “Y-02” is stored as the input user ID is extracted among all of the pieces of setting data with the use flag “Y” affixed thereto. When the output instruction is issued by the operator identified by the input user ID, Y-01, the host computer connection data (ID: 1010) is extracted from the setting data table TB. When the output instruction is issued by the operator identified by the input user ID, Y-02, the host computer connection data (ID: 1011) is extracted from the setting data table TB.

The controller 51 outputs the analysis result to the host computer HC in accordance with the condition based on the extracted host computer connection data (ID: 1613).

When the processing steps are completed, the controller 51 determines whether or not the logoff instruction is received (step S1614). When the controller 51 determines that the logoff instruction was received (step S1614: YES), the controller 51 returns to the processing step of S401 illustrated in FIG. 4. When the controller 51 determines that the logoff instruction was not received (step S1614: NO), the controller 51 determines whether or not the shutdown instruction is received (step S1615). When the controller 51 determines that the shutdown instruction was not received (step S1615: NO), the controller 51 returns to the processing step of S1602 to repeat the processing steps described above. When the controller 51 determines that the shutdown instruction was received (step S1615: YES), the controller 51 ends the processing steps to return to the operation illustrated in FIG. 4.

As described above, the present embodiment is advantageous in that, in the case where the setting data of the measurement mechanism such as optical axis adjustment data (ID: 1001) and sensitivity adjustment data (ID: 1002) is changed by the serviceman authority to any optimal values prior to the sample test by the user authority, the user authority can test the sample based on the changed setting data without optimizing the setting data again. In the case where the host computer connection data is changed by the serviceman authority, only the setting data to which the serviceman authority is entitled (ID: 1012) is updated, while the setting data of ID: 1010 and ID: 1011 to which the user authority is entitled remains unchanged. Accordingly, the information output from the information processing device 5 under any condition irrelevant to the operator's intention can be prevented even in the case where the host computer connection data is updated during the maintenance by the serviceman.

The present embodiment is further advantageous in that the setting data which can be inputted and accessed by the user authority, more specifically, the host computer connection data, is separately stored as independent setting data by each input user ID. Accordingly, when an operator who is entitled to the user authority changes the setting data, the setting data of another operator who is entitled to the user authority remains unchanged.

The present invention is not necessarily limited to the embodiment described above, and can be variously modified within the scope of purpose of the present invention. For example, according to the embodiment described above, all of the pieces of setting data are stored without distinction in a single storage device as illustrated in the setting data table TB illustrated in FIG. 3. However, the present invention is not necessarily limited thereto, and for example, the present invention may have the following structure.

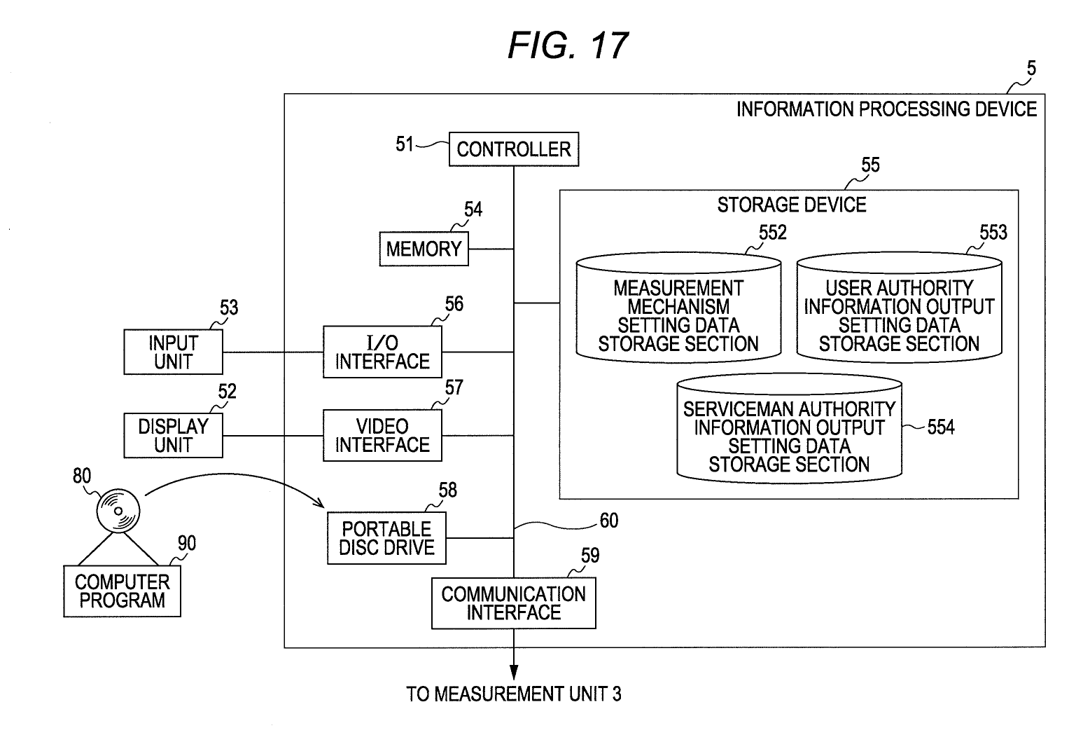

FIG. 17 is a block diagram illustrating a structure of an information processing device 5 according to another embodiment of the present invention. As illustrated in FIG. 17, a storage device 55 of the information processing device 5 includes a first storage section 552 for storing therein setting data of a measurement mechanism used by the user authority and the serviceman authority, a second storage section 553 for storing therein setting data relating to information output used by the user authority, and a third storage section 554 for storing therein setting data relating to information output used by the serviceman authority.

When the setting data of the measurement mechanism is updated by the serviceman authority, the controller 51 stores the updated setting data in the measurement mechanism setting data storage section (first storage section) 552. When the setting data relating to the information output is updated by the user authority, the controller 51 stores the updated setting data in the user authority information output setting data storage section (second storage section) 553. When the setting data relating to the information output is updated by the serviceman authority, the controller 51 stores the updated setting data in the serviceman authority information output setting data storage section (third storage section) 554.

To operate the apparatus by the user authority, the controller 51 reads the setting data of the measurement mechanism stored in the measurement mechanism setting data storage section 552, and the setting data relating to the information output stored in the user authority information output setting data storage section 553, and carries out the operation based on the read setting data.

To operate the apparatus by the serviceman authority, the controller 51 reads the setting data of the measurement mechanism stored in the measurement mechanism setting data storage section 552, and the setting data relating to the information output stored in the serviceman authority information output setting data storage section 554, and carries out the operation based on the read setting data.

According to the embodiment described above, all of the pieces of setting data are stored in a single table. However, there may be provided different databases which respectively store therein a group of setting data used by the serviceman authority, a group of setting data used by the administrator authority, and a group of setting data used by the user authority.

According to the embodiment described above, the service icon for calling the screen for inputting the setting data of the measurement mechanism such as sensitivity adjustment data and hand position adjustment data is not displayed on the menu screen by the administrator authority and the user authority so that these setting data cannot be inputted. However, the present invention is not necessarily limited thereto. For example, the service icon may be inactivated and then displayed on the menu screen, or the input boxes on the input screen may be inactivated and then displayed so as not to receive input.

According to the embodiment described above, a plurality of input user IDs are set for the operators who are entitled to the user authority to independently store the setting data relating to the information output for each of the user IDs, so that the different setting data can be used and changed by each operator who is entitled to the user authority. Similarly, a plurality of input user IDs may be set for the operators who are entitled to the serviceman authority to independently store the setting data of the measurement mechanism for each of the user IDs, so that the different setting data can be used and changed by each operator who is entitled to the serviceman authority. Similarly, a plurality of input user IDs may be set for the operators who are entitled to the administrator authority to independently store the setting data of the information output for each of the user IDs, so that the different setting data can be used and changed by each operator who is entitled to the administrator authority.

What is claimed is:

1. A sample testing apparatus which can be operated by a plurality of use authorities, comprising:
a measurement mechanism for measuring a sample;
a setting data storage section for storing setting data used to operate the apparatus, the setting data at least comprising mechanism control data relating to operation control of the measurement mechanism and information output data relating to information output; and
a controller for controlling an operation of the sample testing apparatus, wherein
the controller:
receives input of identification information for identifying an operator;
authorizes change of the mechanism control data and change of the information output data when the received identification information corresponds to a first use authority to which an operator in charge of maintenance is entitled;
authorizes the change of the information output data while forbidding the change of the mechanism control data when the received identification information corresponds to a second use authority to which an operator in charge of testing a sample is entitled; and
operates, when the received identification information corresponds to the second use authority, the sample testing apparatus based on the mechanism control data stored in the setting data storage section and the information output data inputted by the operator identified by the received identification information.

2. The sample testing apparatus of claim 1, wherein
the controller operates, when the received identification information corresponds to the first use authority, the apparatus based on the mechanism control data inputted by the operator identified by the received identification information and the information output data inputted by the operator identified by the received identification information.

3. The sample testing apparatus of claim 1, wherein
the setting data further comprising an analysis condition data relating to conditions for analyzing measurement data obtained by sample measurement carried out by the measurement mechanism,
the controller:
authorizes change of the analysis condition data when the received identification information corresponds to a third use authority to which an administrator is entitled, and
forbids the change of the analysis condition data when the received identification information corresponds to the first or second use authority.

4. The sample testing apparatus of claim 1, wherein
the setting data further comprising a suspending condition data relating to conditions for suspending the measurement carried out by the measurement mechanism,
the controller:
authorizes change of the suspending condition data when the received identification information corresponds to the first or second use authority; and
operates, when the received identification information corresponds to the second use authority, the apparatus based on the suspending condition data inputted by the operator corresponding to the received identification information.

5. The sample testing apparatus of claim 1, further comprising a display unit, wherein
the controller makes the display unit display a first screen for inputting the change of the mechanism control data and a second screen for inputting the change of the information output data.

6. The sample testing apparatus of claim 5, wherein
the controller restricts the display of the first screen when the received identification information corresponds to the second use authority.

7. The sample testing apparatus of claim 3, further comprising a display unit, wherein
the controller makes the display unit display a first screen for inputting the change of the mechanism control data, a second screen for inputting the change of the information output data, and a third screen for inputting the change of the analysis condition data.

8. The sample testing apparatus of claim 7, wherein
the controller restricts the display of the third screen when the received identification information corresponds to the first or second use authority.

9. The sample testing apparatus of claim 7, wherein
the controller restricts the display of the first screen when the received identification information corresponds to the second or third use authority.

10. A sample testing apparatus which can be operated by a plurality of use authorities, the apparatus comprising:
a measurement mechanism for measuring a sample;
an identification information receiving unit for receiving input of identification information for identifying an operator;
a first storage section for storing mechanism control data relating to operation control of the measurement mechanism;
a second storage section for storing information output data relating to information output; and
a controller, wherein
the controller:
stores the mechanism control data changed by the operator in the first storage section when the identification information received by the identification information receiving unit corresponds to a first use authority to which an operator in charge of maintenance is entitled; and
stores the information output data changed by the operator in the second storage section when the identification information received by the identification information receiving unit corresponds to a second use authority to which an operator in charge of testing a sample is entitled, and operates the apparatus based on the data stored in the first and second storage sections.

11. The sample testing apparatus of claim 10, further comprising
a third storage section for storing the information output data relating to information output; wherein
the controller stores the information output data changed by the operator in the third storage section when the identification information received by the identification information receiving unit corresponds to the first use authority.

12. The sample testing apparatus of claim 11, wherein
the controller operates the apparatus based on the data stored in the first storage section and the third storage section when the identification information received by the identification information receiving unit corresponds to the first use authority.

13. A sample testing apparatus which can be operated by a plurality of use authorities, comprising:
a measurement mechanism for measuring a sample;
an identification information receiving means for receiving input of identification information for identifying an operator;
a setting data storage section for storing setting data used to operate the apparatus, the setting data at least comprising setting data relating to operation control of the measurement mechanism and setting data relating to information output;
a first change accepting means for accepting change of the setting data relating to operation control of the measurement mechanism;
a second change accepting means for accepting change of the setting data relating to information output; and
a controller, wherein
the controller:
authorizes the changes of the setting data accepted by the first and second change accepting means when the identification information received by the identification information receiving means corresponds to a first use authority to which an operator in charge of maintenance is entitled;
forbids the change of the setting data accepted by the first change accepting means and authorizes the change of the setting data accepted by the second change accepting means when the identification information received by the identification information receiving means corresponds to a second use authority to which an operator in charge of testing a sample is entitled; and
operates, when the identification information received by the identification information receiving means corresponds to a second use authority, the apparatus based on the setting data changed by the first change accepting means and the setting data changed by the operator identified based on the received identification information using the second change accepting means.

14. The sample testing apparatus of claim 13, wherein
the controller further operates, when the identification information received by the identification information receiving means corresponds to the first use authority, the apparatus based on the setting data changed by the first change accepting means and the setting data changed by the operator identified based on the received identification information using the second change accepting means.

15. The sample testing apparatus of claim 13, wherein
the setting data further comprising setting data relating to conditions for analyzing measurement data obtained by the sample measurement carried out by the measurement mechanism,
the sample testing apparatus further comprising a third change accepting unit for accepting change of the setting data relating to the analysis conditions,
the controller:
authorizes the change of the setting data by the third change accepting means when the identification information received by the identification information receiving means corresponds to a third use authority to which a administrator is entitled; and
forbids the change of the setting data by the third change accepting means when the identification information received by the identification information receiving means corresponds to the first or second use authority.

16. The sample testing apparatus of claim 15, wherein
the controller operates, when the identification information received by the identification information receiving means corresponds to the second use authority, the sample testing apparatus based on the setting data changed by the first change accepting means, the setting data changed by the third change accepting means, and the setting data changed by the operator identified based on the received identification information using the second change accepting means.

17. The sample testing apparatus of claim 13, wherein
the second change accepting means accepts change of the setting data relating to conditions for suspending the measurement by the measurement mechanism.

18. The sample testing apparatus of claim 13, further comprising a display, wherein
the controller causes the display to display a first change accepting screen as the first change accepting means, and to display a second change accepting screen as the second change accepting means.

19. The sample testing apparatus of claim 18, wherein
the controller forbids the change of the setting data by restricting the display of the first change accepting screen when the identification information received by the identification information receiving means corresponds to the second use authority.

20. A method for controlling a sample testing apparatus provided with a measurement mechanism for measuring a sample, and a setting data storage section for storing setting data used to operate the apparatus, wherein the setting data at least comprises mechanism control data relating to operation control of the measurement mechanism and information output data relating to information output, the method comprising:
receiving input of identification information for identifying an operator;
authorizing change of the mechanism control data and change of information output data when the received identification information corresponds to a first use authority to which an operator in charge of maintenance is entitled;
authorizing the change of the information output data while forbidding the change of the mechanism control data stored in the setting data storage section when the received identification information corresponds to a second use authority to which an operator in charge of testing a sample is entitled; and
operating the sample testing apparatus based on the mechanism control data and the information output data inputted by the operator corresponding to the received identification information when the received identification information is the identification information corresponding to the second use authority.
